(19) United States
(12) Patent Application Publication
(10) Pub. No.: US 2026/0112538 A1
(43) Pub. Date: Apr. 23, 2026

(54) A TANK SHUNT AND A TRANSFORMER PROVIDED WITH SUCH A TANK SHUNT

(71) Applicant: Hitachi Energy Ltd, Zürich (CH)

(72) Inventors: Gianluca BUSTREO, Mirano (VE) (IT); Nicolo PAOLO, Padova (IT)

(21) Appl. No.: 19/475,037

(22) PCT Filed: Apr. 12, 2024
(86) PCT No.: PCT/EP2024/059976

§ 371 Date: Oct. 13, 2025

Related U.S. Application Data
(60) Provisional application No. 63/459,307, filed on Apr. 14, 2023.

(51) Int. Cl. H01F 27/34; H01F 27/02; H01F 27/36

(52) U.S. Cl. CPC H01F 27/346; H01F 27/02; H01F 27/366

(57) ABSTRACT

A transformer including an active part, a transformer tank, and one or more tank shunts. The active part includes a core and windings around the core. The transformer tank includes a tank wall, and the transformer tank houses the active part of the transformer. The one or more tank shunts are configured to capture a leakage of a magnetic flux from the windings, in which the one or more tank shunts are arranged between the windings and the tank wall. Each one of the one or more tank shunts also includes a casing, in which the casing of the one or more tank shunts houses a magnetic fluid.

### CROSS REFERENCE TO RELATED APPLICATIONS

This application is a 35 U.S.C. § 371 national stage application of International Application No. PCT/EP2024/059976 filed on Apr. 12, 2024, which in turn claims priority to U.S. Provisional Patent Application No. 63/459,307 filed on Apr. 14, 2023, the disclosures and content of which are incorporated by reference herein in their entirety.

### TECHNICAL FIELD

The present disclosure generally relates to a transformer (including reactors, earthing transformer, etc.) provided with a tank shunt for reducing stray losses caused by leakage of magnetic flux from the windings of the transformer. The present disclosure also relates to a tank shunt as such.

### BACKGROUND

A transformer is a static piece of apparatus with two or more windings which, by electromagnetic induction, transforms a system of alternating voltage and current into another system of voltage and current usually of different values and at the same frequency for the purpose of transmitting electrical power. The transformer includes a transformer tank that houses the active part of the transformer. The active part of the transformer includes the core and the windings. The active part may also include a clamping structure for clamping a laminated core. In the aforementioned process, stray losses are caused by leakage of magnetic flux from windings and mainly impinging the tank walls.

In some examples, tank shunts are used to reduce the stray losses caused by leakage of magnetic flux from the windings. Conventionally, the tank shunts are elements made of parallel, laminated sheets of materials like GO (Grain Oriented) steels. Further, by using the above-mentioned tank shunts, the stray losses and the local temperature rises in the transformer tank are reduced.

However, the disadvantage of this solution is that during load stage the leakage of magnetic flux goes into the tank shunts and causes vibrations in said sheets. Further, the vibrations are transferred through tank walls of the tank shunts and are readable as noise generated by the tank walls which contributes to the total transformer load noise.

### SUMMARY

Consequently, there is a need for tank shunts that collect the flux leakages from windings and at the same time reduce the noise generated by the vibrations of laminated steel.

It is therefore an object of the present disclosure to provide a transformer and tank shunts that can efficiently collect the magnetic flux leakages and at the same time generates loss noise. As an example, the noise can be less than compared to the noise generated by the vibrations of the laminated steel material of conventional tank shunts.

According to a first aspect of the present disclosure, a transformer is provided. The transformer comprises a core, two or more windings, a transformer tank, and one or more tank shunts. The core is configured to provide a path for a magnetic flux generated from windings of the transformer. In an example, the transformer tank is housing the active part. Further, the one or more tank shunts are configured to capture a leakage of the magnetic flux from the windings, wherein the one or more tank shunts are arranged between the windings and the tank wall. The tank shunts are, in particular, arranged such that a required minimum dielectric distance from the windings is present.

Each one of the one or more tank shunts comprise a casing. The casing may be made of a non-magnetic material. The casing of said one or more tank shunts houses a magnetic fluid. Each of the tank shunts may comprise several chambers, each chamber housing a magnetic fluid. The chambers may be formed by the casing. The casing may also provide a separation of the chambers from each other.

The tank shunts may be at earth potential. The casings may be electrically connected to the tank wall. The mechanical connection may be established by a fixation of the tank shunts to the tank wall, e.g. by welding or bolting. This fixation may also establish the electrical connection of the tank shunts to the tank wall. It is also possible that the electrical connection may be established or strengthened by an additional grounding conductor. The grounding conductor may be a conductor, such as a cable, connected to the tank shunt.

Advantageously, in the magnetic fluid there is no electric field of sufficient intensity to allow relevant electron or ion conduction, because the tank shunts are electrically connected to the tank walls, which are at earth potential. Since no significant induced currents can circulate in the magnetic fluid, the load losses induced on one or more tank shunts are drastically reduced.

Accordingly, the induced load losses in the fluid ferromagnetic tank shunts are therefore limited to the work necessary to change the orientation of magnetic bi-poles of a ferromagnetic material in the magnetic fluid, according to the change of the direction of the leakage magnetic flux.

In some embodiments, the casing may house a compressible fluid in addition to said magnetic fluid, wherein the compressible fluid is configured to adopt volume changes of the magnetic fluid. The compressible fluid may be a non-magnetic fluid. The compressible fluid may be separated from the magnetic fluid by a movable wall. In an example, the compressible fluid may be a dry inert gas. Further, in another example, the dry inert gas may be nitrogen gas.

In some embodiments, the magnetic fluid comprises magnetic particles dispersed in a carrier fluid. The carrier fluid may be a non-magnetic fluid. The magnetic fluid may be one or more of a ferrofluid or a magnetorheological fluid (MR fluid).

In an example, the magnetic fluid may be a ferrofluid. A ferrofluid is a colloidal fluid comprising or consisting of nanoscale ferromagnetic particles suspended in a carrier fluid. The ferromagnetic particles may be coated by a surfactant to inhibit clumping.

The carrier fluid may be an insulant liquid. In an example, the carrier fluid may be oil or may comprise oil. By using an insulant liquid for the carrier fluid, circulation of an induced current can be reduced. It is also possible that the carrier fluid is water or comprises water. In another example, the carrier fluid is in a gel state and may have a higher viscosity than conventional fluids.

In some embodiments, the magnetic fluid may be a magnetorheological fluid (MR fluid). A MR fluid comprises or is made of micrometre-scale ferromagnetic particles dispersed in a carrier fluid.

In some embodiments, the casing of said one or more tank shunts may be constructed to prevent ingress and egress of fluids into or out of the casing.

Furthermore, in some embodiments, the casings of said one or more tank shunts comprise or are constituted by one or more of stainless steel, aluminum, plastic, plastic composite, or other non-magnetic materials compatible with a transformer cooling fluid.

In some embodiments, the one or more tank shunts may include a plurality of parallel casings, wherein each casing is elongated and extending with its longitudinal direction in parallel with a longitudinal direction of the adjacent transformer active part. The tank shunts may comprise a plurality of chambers, each chamber housing a magnetic fluid. The chambers may be separated, e.g., by a part of a casing. The plurality of chambers may be formed by the same casing or by different, separate casings. The longitudinal direction of an active part is the direction of a winding axis of the windings. This direction is also the direction of a leg of a core around which the windings are wound.

In another embodiment, the one or more tank shunts may include a plurality of parallel casings, each casing being elongated and extending with its longitudinal direction perpendicular to a longitudinal direction of the adjacent transformer active part. The one or more tank shunts may include a plurality of parallel chambers, the chambers being formed by a single casing or by several casings.

It is also possible that the transformer comprises one or more tank shunts arranged in a longitudinal direction and one or more tank shunts arranged perpendicular to the longitudinal direction.

In addition, in some embodiments, the transformer active part may have a central longitudinal axis and a side surface that extends in parallel with said longitudinal axis. Further, the one or more tank shunts may extend in parallel with said side surface, between said side surface and the tank wall of the transformer tank.

In some embodiments, the transformer active part may have a central longitudinal axis and an end surface that extends perpendicular to the longitudinal axis. Further, the one or more tank shunts may extend in parallel with said end surface, between said end surface and the tank wall of the transformer tank.

In some embodiments, the transformer may comprise a dampener placed between the tank wall and the one or more tank shunts. The dampener may further assist the one or more tank shunts to absorb the vibrations. The fixation may be arranged between one or more dampeners or extend through a dampener.

In an embodiment, the transformer may be a fluid-immersed transformer, wherein a fluid in which the active part of the transformer is immersed may be oil. In an example, the fluid may be an ester (natural/synthetic), a silicon oil etc.

According to the second aspect of the present disclosure, a tank shunt for a transformer is provided. The tank shunt comprises a casing. The casing may be of a non-magnetic material. Further, a magnetic fluid is housed inside the casing. The tank shunt may comprise any structural and functional characteristics as disclosed for the tank shunt in the foregoing.

In some embodiments, the casing may house a compressible fluid in addition to said magnetic fluid. The compressible fluid is configured to adopt volume changes of the magnetic fluid.

In some embodiments, the compressible fluid may be a dry inert gas. Further, in some other embodiments, the casing of the tank shunt may comprise or be constituted by one or more of stainless steel, aluminum, plastic, plastic composite, or other non-magnetic materials compatible with a transformer cooling fluid.

In some embodiments, any of the above aspects may additionally have features identical with or corresponding to any of the various features as explained above for any of the other aspects.

Other advantages may be readily apparent to one having skill in the art. Certain embodiments may have some, or all of the recited advantages.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIGS. 1A and 1B disclose the laminated magnetic tank shunts and non-laminated magnetic tank shunts of the prior art.

FIG. 2 discloses a transformer tank including magnetic tank shunts of the prior art;

FIG. 3A discloses vertical arrangement of tank shunts according to some embodiments of the present disclosure;

FIG. 3B discloses horizontal arrangement of tank shunts according to some embodiments of the present disclosure.

FIG. 4 discloses an exploded view of a single phase of a transformer active part along with the location of a fluid ferromagnetic tank shunt with respect to the position of windings according to some embodiments of the present disclosure;

FIG. 5A discloses a side view of a tank shunt according to some embodiments of the present disclosure; and

FIG. 5B discloses a front view of a tank shunt according to some embodiments of the present disclosure.

FIG. 6 discloses a schematic, sectional view of a transformer according to some embodiments of the present disclosure.

### DETAILED DESCRIPTION

Aspects of the present disclosure will be described more fully hereinafter with reference to the accompanying drawings. The apparatus disclosed herein can, however, be realized in many different forms and should not be construed as being limited to the aspects set forth herein. Like numbers in the drawings refer to like elements throughout.

The terminology used herein is for describing particular aspects of the disclosure only and is not intended to limit the disclosure. It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

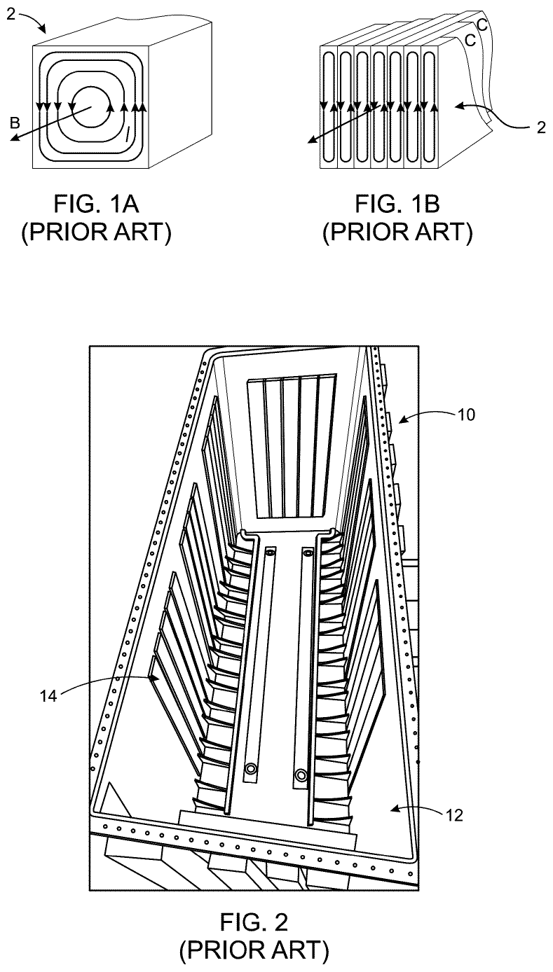

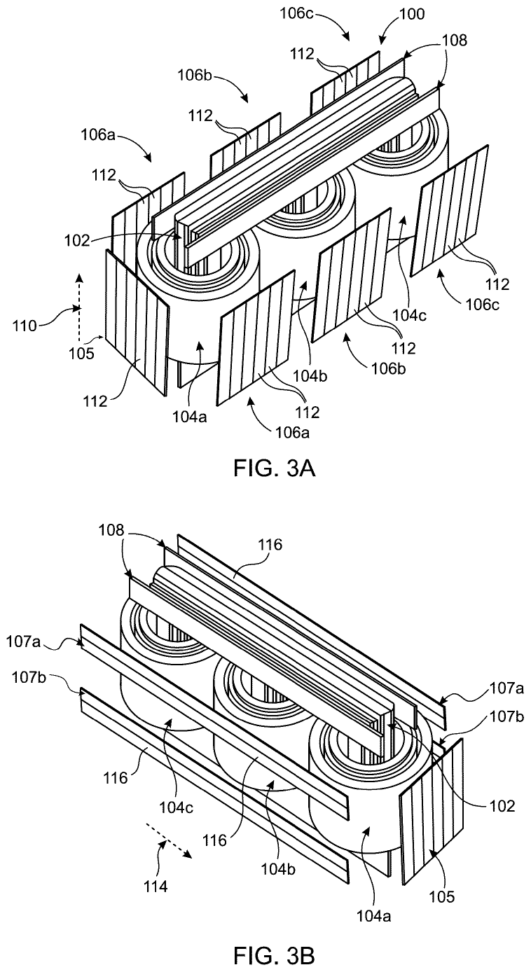

As disclosed in FIG. 1A (Prior Art), when leakage flux lines B from windings of the transformer enter a magnetic tank shunt 2, eddy currents I are generated which further generates huge eddy load losses. Conventionally, to overcome this problem, magnetic tank shunts 2 are made from a solid material, e.g. the same material as of a magnetic core, are laminated and protected by a thin coating of varnish or oxide film C (as seen in FIG. 1B). Due to these laminations C, electrons cannot cross the insulating gap between the laminations C and so are unable to circulate on wide arcs.

As depicted in FIG. 2 (Prior Art) a transformer (not shown) is housed in a transformer tank 10. The transformer tank 10 comprises tank walls 12. Further, the laminated magnetic tank shunts 14 explained in the aforementioned paragraph are fixed on the tank walls 12. Further, the magnetic tank shunts 14 are used to reduce the stray losses caused by leakage of magnetic flux from the windings and mainly impinging the tank walls 12. Thereby, the magnetic tank shunts reduce eddy load losses and local temperature rises on transformer tank 10. The disadvantage of this solution is that during load stage the magnetic flux goes into the magnetic tank shunts 14 causing vibrations. The vibrations are transferred through the tank walls 12 and generate a noise, which contributes to the total noise of the load on the transformer (not shown).

According to some embodiments of the present subject matter, as depicted in FIG. 3A, an active part of transformer 100 is provided. The active part of transformer 100 includes a laminated core 102, windings 104a, 104b, and 104c, one or more fluid ferromagnetic tank shunts 105, 106a, 106b, and 106c, and clamps 108.

Each fluid ferromagnetic tank shunt 105, 106a, 106b, and 106c comprises a non-magnetic casing 112 filled with a magnetic fluid, such as ferrofluid. A ferrofluid comprises nanoscale ferromagnetic particles suspended in a carrier fluid. The magnetic attraction of nanoparticles is weak enough to prevent magnetic clumping or agglomeration. Ferrofluids usually do not retain magnetization in the absence of an externally applied field. As an example, the ferromagnetic particles may comprise materials such as iron oxide, magnetite or gamma iron oxide.

Further, the active part of transformer 100 is housed inside a transformer tank 10 (as shown in FIG. 2). In some embodiments, the one or more fluid ferromagnetic tank shunts 106a, 106b, and 106c may be arranged between the tank wall 12 (as shown in FIG. 2) and the winding 104a, 104b, and 104c of the active part of transformer 100. The tank shunts 105, 106a, 106b, and 106c are arranged such that a dielectric minimum distance from the windings 104a, 104b, and 104c is taken into account. Dielectric distance may be referred to as a distance at which the medium between the windings 104a, 104b, and 104c and the fluid ferromagnetic tank shunts 105, 106a, 106b, and 106c does not conduct electricity between the winding and the tank shunt upon operation of the transformer 100.

The one or more fluid ferromagnetic tank shunts 105, 106a, 106b, and 106c may be fixed on the tank walls 12 (as shown in FIG. 2). The fixation may also establish an electrical connection of the tank shunts 105, 106a, 106b, and 106c and the tank walls 12 such that the tank shunts are on earth potential. The connection may be done by a fixation such as bolting or welding. It is also possible that the mechanical connection is established by a fixation, such as bolting or welding, and the electrical connection is established or strengthened by an additional grounding conductor.

The one or more fluid ferromagnetic tank shunts 105, 106a, 106b, and 106c may surround the active part of transformer 100. In the shown embodiment, the tank shunts 105, 106a, 106b, and 106c are fixed vertically to the tank walls 12. The vertical direction corresponds to the direction of the winding axis, which can be also denoted as a longitudinal direction.

Further, the clamps 108 are configured to hold the laminated cores 102 together.

In an embodiment, each tank shunt 105, 106a, 106b, and 106c may include a plurality of parallel casings 112. It is also possible that one or more of the tank shunts 105, 106a, 106b, and 106c comprises only a single casing. Each casing 112 forms a chamber. Each casing 112 comprises a magnetic fluid and is separate from another casing. In addition, each casing 112 is elongated and extended in vertical direction (marked by arrow 110). The tank shunts 105, 106a, 106b, and 106c are located side by side along the tank walls 12.

Further, the vertical arrangement of each of the casings 112 may be aligned with a corresponding single winding (single phase) 104a, 104b, and 104c of the transformer 100 to capture the flux leakage from said individual winding 104a, 104b, and 104c. Each tank shunt 105, 106a, 106b, and 106c has a width corresponding to the width of the winding 104a, 104b, and 104c of an associated magnetic core part and is arranged opposite to said winding 104a, 104b, and 104c. There is spacing between neighboring tank shunts 105, 106a, 106b, and 106c having vertically directed casings. The tank shunts 106a, 106b, and 106c are arranged at both sides of windings 104a, 104b, and 104c so that the magnetic flux from the same phase will build up closed loops via the tank shunts 106a, 106b, and 106c. Tank shunts 106a, 106b, and 106c are located at opposite longitudinal side faces and tank shunts 105 are located at opposite end faces of the active part 100.

FIG. 3B discloses another embodiment, in which each tank shunt 105, 107a, 107b may include a plurality of parallel casings 116. It is also possible that one or more of the tank shunts 105, 107a, 107b comprises only a single casing, Each casing 116 forms a chamber housing a magnetic fluid. Further, casings 116 of the tank shunts 107a and 107b located along the windings 104a, 104b, and 104c are transversely extended continuously in horizontal direction (marked by arrow 114). Further, the horizontal arrangement of each of the casings 116 may align with all the windings (three phase) 104a, 104b, and 104c of the transformer 100 to capture the flux leakage from all the windings 104a, 104b, and 104c.

In an example, the horizontal arrangement of each of the casings 116 may be utilized in large transformers. Each casing 116 has a length of and covers the width of two or more, in this case all three, windings 104a, 104b, and 104c of the transformer 100. The horizontal arrangement may be more cost-efficient than the vertical arrangement, as less, but larger, components are required.

The tank shunts 107a, 107b on the longitudinal ones of the tank walls are arranged such that a gap is provided between one or more upper tank shunts 107a and one or more lower tank shunts 107b. Thereby, material can be saved. The gap is larger than the gaps between casings of the same upper tank shunt 107a or gaps between the same lower tank shunt 107b. It is also possible that the casings of the same tank shunt 107a, 107b are without any gaps or a single casing is provided for one tank shunt 107a, 107b.

The tank shunt 105 on the front side is arranged in a vertical arrangement. This tank shunt 105 is provided without larger gaps between the casings. However, it is also possible to provide gaps between these casings.

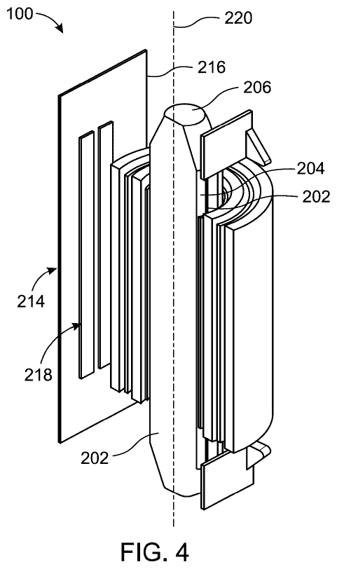

In an embodiment of the present disclosure as shown in FIG. 4, a cross sectional view of a limb of the active part of transformer 100, e.g. as shown in FIG. 3A, is disclosed. The active part of transformer 100 includes a laminated core 202. In addition, as depicted by FIG. 4, the active part of transformer is housed in a transformer tank 214. The transformer tank 214 has a tank wall 216. The transformer tank 214 also includes one or more fluid ferromagnetic tank shunts 218, which are attached on the tank wall 216 by one or more of welding or bolting. In some other embodiments, the one or more fluid ferromagnetic tank shunts 218 may be located between the tank wall 216 and the core 202 of the active part of transformer 100.

In addition, in an embodiment, the one or more fluid ferromagnetic tank shunts 218 may include a plurality of parallel casings, wherein each casing is elongated and extended with its longitudinal direction in parallel with a longitudinal axis 220 of the adjacent active part of transformer 100.

In another embodiment, the one or more fluid ferromagnetic tank shunts 218 may include a plurality of parallel casings, wherein each casing is elongated and extended with its longitudinal direction perpendicular to the longitudinal axis 220 of the adjacent active part of transformer 100.

Furthermore, in some embodiments, the limb of the core 202 may have a central longitudinal axis 220 and a side surface 204 that extend in parallel with said longitudinal axis 220. In an example, the one or more fluid ferromagnetic tank shunts 218 may extend in parallel with said side surface 204, between said side surface 204 and the tank wall 216 of the transformer tank 214.

In some embodiments of the present disclosure, the limb of the core 202 may have a central longitudinal axis 220 and an end surface 206 that extend perpendicular to the longitudinal axis 220. Further, the one or more fluid ferromagnetic tank shunts 218 may extend in parallel with said end surface 206, between said end surface 206 and the tank wall 216 of the transformer tank 214.

Further, in some embodiments, the active part of transformer 100 may be a fluid-immersed transformer, wherein a fluid in which the active part of transformer 100 is immersed may be oil. In other embodiments, the active part of transformer 100 may be immersed in an ester (natural/synthetic), a silicon oil etc.

In the shown embodiment several tank shunts 218 or a single tank shunt 218 with separate casings is provided at a side of one winding. It is also possible that the tank shunt 218 comprises only a single casing or several casings without gaps between the casings.

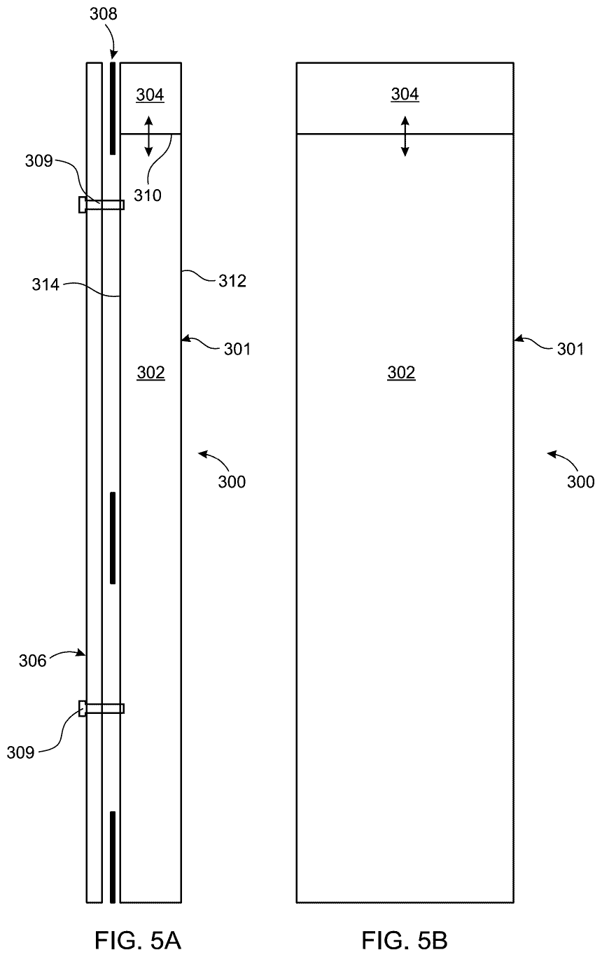

FIG. 5A discloses a side view of a fluid ferromagnetic tank shunts 300. The fluid ferromagnetic tank shunt 300 may be any of the tank shunts disclosed in the foregoing embodiments.

The fluid ferromagnetic tank shunts 300 comprises a casing 301 constituted by a non-magnetic material. The non-magnetic material may be one or more of stainless steel material, aluminum, plastic, plastic composite, etc. Further, the material used for manufacturing of the casing 301 may be non-reactive to oil and high temperatures.

The casing 301 of the fluid ferromagnetic tank shunts 300 may house a magnetic fluid 302 and a compressible fluid 304. The compressible fluid 304 is adapted to accommodate change in volume of the magnetic fluid 302. The change in volume of the magnetic fluid 302 is due to temperature variations of the transformer (not shown). Thus, the tank shunts 300 comprise a pressure expansion chamber. The changes in volume of the magnetic fluid 302 are absorbed by the compressible fluid 304. The overall volume of the casing 301, however, remains constant.

Furthermore, in some embodiments, the magnetic fluid 302 and the compressible fluid 304 could be separated by a movable membrane 310. The membrane can be configured to navigate in upward and downward direction (marked by the arrow) to accommodate the change in volume of the magnetic fluid 302. It is also possible that only some parts of the membrane 310 extend upwards or downwards while the edges of the membrane remain fixed.

Furthermore, in some embodiments, the magnetic fluid 302 is a ferrofluid. The ferrofluid is a colloidal liquid made of nanoscale ferromagnetic particles suspended in a carrier fluid. In an example, the carrier fluid may be oil. In another example, the magnetic fluid may be in a gel state and may have a higher viscosity than conventional fluids. In another embodiment, the magnetic fluid 302 may be a magnetorheological fluid (MR fluid). The MR fluid is made of micrometre-scale ferromagnetic particles.

In addition, in some embodiments, the compressible fluid 304 may be a dry inertial gas. In one example, the dry inertial gas is nitrogen gas.

In some embodiments, an element 308 configured to provide dampening could be sandwiched between the fluid ferromagnetic tank shunts 300 and the tank wall 306. The element 308 can be also denoted as dampener 308. It is also possible that a dampener 308 is provided while the fluid ferromagnetic tank shunt 300 does not comprise a compressible fluid 304 in addition to the magnetic fluid 302 or vice versa. The damper 308 may comprise dampening material such as rubber or cork, for example.

The tank shunts 300 are fixed by a fixation 309 to the tank wall 306. The fixation 309 is in form of bolts. The fixation 309 may establish both the mechanical and electrical connection.

In an embodiment, FIG. 5B depicts a front view of the fluid ferromagnetic tank shunts 300. As disclosed in FIG. 5A, the fluid ferromagnetic tank shunts 300 comprises a casing 301 constituted by a non-magnetic material. The non-magnetic material may be one or more of stainless steel material, aluminum, plastic composite, etc. Further, the material used for manufacturing of the casing 301 may be non-reactive to oil and high temperatures.

The casing 301 of the fluid ferromagnetic tank shunts 300 may include a magnetic fluid 302 and compressible fluid 304. The compressible fluid 304 is configured to accommodate change in volume of the magnetic fluid 302. The change in volume of the magnetic fluid 302 can be due to temperature variations of the transformer (not shown).

Furthermore, in the magnetic fluid 302 relative distances between atoms are higher than in a solid material (magnetic tank shunt used in the embodiment of FIG. 2.). Accordingly, in a fluid, interaction forces are significantly lower than in a solid material. Therefore, also mechanical vibrations are significantly lower than in a solid material. Furthermore, also due to the larger relative distances between the atoms, a circulation of the induced current in not permitted or strongly limited. In addition, the magnetic fluid 302 may be an insulant liquid, thereby making it harder to circulate an induced current.

In addition, the fluid ferromagnetic tank shunts 300 are electrically connected to the tank wall 306, which are at earth potential. Hence, there is no electric field of sufficient intensity to allow electron or ion conduction. Since no significant induced currents can circulate in the magnetic fluid 302, the load losses induced on fluid ferromagnetic tank shunts 300 are drastically reduced. In the above configuration the induced load losses on the fluid ferromagnetic tank shunt 300 may be limited to the work necessary to change the orientation of magnetic bi-poles of a ferromagnetic material in the magnetic fluid 302. The orientation changes in accordance with the change of direction of the winding's leakage flux. As an example, the direction changes with a frequency of 50 Hz. The magnetic fluid 302 does not vibrate due to variation of magnetic flux. Therefore, the total noise of the transformer (not shown) may be reduced drastically.

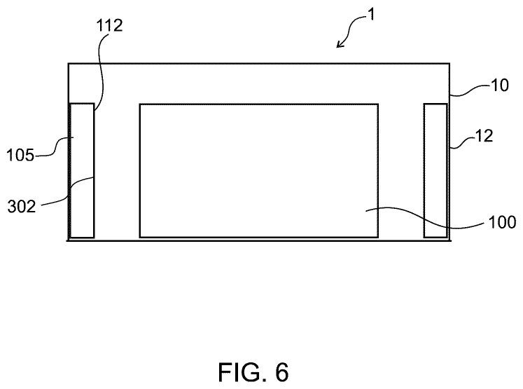

FIG. 6 shows a schematic view of a transformer 1 comprising an active part 100 located in a transformer tank 10. The transformer tank 10 comprises a tank wall 12 to which one or more tank shunts 105 are fixed. The tank shunts 105 comprise a casing 112 filled by a magnetic fluid 302. The tank shunts 105 may comprise any structural and functional features disclosed in the foregoing embodiments. Also the transformer 1, transformer tank 12 and active part 100 may comprise any structural and functional features disclosed in the foregoing embodiments and/or disclosed in connection with the prior art.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of some embodiments, those skilled in the art will recognize that the embodiments herein can be practiced with modification within the scope of the disclosure.

### REFERENCE SIGNS

1 transformer
2 magnetic tank shunt
10 transformer tank
12 tank wall
14 laminated magnetic tank shunts
100 active part of transformer
102 laminated core
104a, 104b, 104c winding
105 fluid ferromagnetic tank shunt
106a, 106b, 106c fluid ferromagnetic tank shunts
107a, 107b fluid ferromagnetic tank shunt
108 clamp
110 vertical direction
112 casing
114 horizontal direction
116 casing
202 core
204 side surface
206 end surface
214 transformer tank
218 fluid ferromagnetic tank shunts
220 longitudinal axis of core
300 fluid ferromagnetic tank shunts
301 casing
302 magnetic fluid
304 compressible fluid
306 tank wall
308 element
309 fixation
310 membrane
B magnetic flux
C lamination
I eddy currents

1-15. (canceled)

16. A transformer, comprising:
an active part comprising a core and windings around the core;
a transformer tank comprising a tank wall, the transformer tank housing the active part of the transformer;
one or more tank shunts configured to capture a leakage of a magnetic flux from the windings, the one or more tank shunts being arranged between the windings and the tank wall; and
characterized in that each one of the one or more tank shunts comprises a casing, wherein the casing houses a magnetic fluid.

17. The transformer as claimed in claim 16, wherein the casing houses a compressible fluid in addition to said magnetic fluid, said compressible fluid being configured to adopt volume changes of the magnetic fluid.

18. The transformer as claimed in claim 16, wherein the one or more tank shunts are attached to the tank wall.

19. The transformer as claimed in claim 16, wherein the magnetic fluid comprises one or more of: a ferrofluid or a magnetorheological fluid (MR fluid).

20. The transformer as claimed in claim 16, wherein the casing is constructed to prevent ingress and egress of fluids into or out of the casing.

21. The transformer as claimed in claim 17, wherein the compressible fluid is a dry inert gas.

22. The transformer as claimed in claim 16, wherein the casing comprises or is constituted by one or more of stainless steel, aluminum, plastic, plastic composite, or other non-magnetic materials compatible with a transformer cooling fluid.

23. The transformer as claimed in claim 16, wherein the one or more tank shunts comprise a plurality of parallel casings, each casing being elongated and extending with its longitudinal direction in parallel with a longitudinal direction of the adjacent core.

24. The transformer as claimed in claim 16, wherein the one or more tank shunts comprise a plurality of parallel casings, each casing being elongated and extending with its longitudinal direction perpendicular to a longitudinal direction of the adjacent core,

25. The transformer as claimed in claim 16, further comprising a dampener placed between the tank wall and the one or more tank shunts.

26. The transformer as claimed in claim 16, wherein the transformer is a fluid-immersed transformer.

27. A tank shunt for a transformer, comprising:
a casing, and
a magnetic fluid housed in said casing, wherein the casing houses a compressible fluid in addition to said magnetic fluid, said compressible fluid being configured to adopt volume changes of the magnetic fluid.

28. The tank shunt as claimed in claim 27, wherein the compressible fluid is a dry inert gas.

29. The tank shunt as claimed in claim 27, wherein the casing of the tank shunt comprises or is constituted by one or more of stainless steel, aluminum, or plastic composite or other non-magnetic materials compatible with a transformer cooling fluid.
